(19) United States
(12) Patent Application Publication
(10) Pub. No.: US 2011/0297490 A1
(43) Pub. Date: Dec. 8, 2011

(54) Caliper brake

(75) Inventors: Brian P. Dennis, Kalamazoo, MI (US); James P. O'Neal, Benton Harbor, MI (US); LynRoy Palmer-Coleman, Stevensville, MI (US)

(73) Assignee: Ausco Products, Inc.

(21) Appl. No.: 12/802,268

(22) Filed: Jun. 4, 2010

(51) Int. Cl. F16D 55/225; F16D 65/20; B60T 1/06; F16D 55/22

(52) U.S. Cl. 188/72.3

(57) ABSTRACT

A caliper brake including a pair of stator pins and first and second stator assemblies slidably mounted on the stator pins. A return spring assembly is provided at each of opposing sides of the brake. Each return spring assembly includes a first off-set bracket extending from the first stator assembly and a second off-set bracket extending from the second stator assembly. The off-set brackets provide support surfaces for spring retaining members, over which a return spring is positioned. The off-set brackets allow for a longer and more powerful return spring as compared to prior art brakes.

### TECHNICAL FIELD

This invention relates to a caliper brake. More specifically, this invention relates to such a caliper brake having an improved return spring assembly that provides an increased biasing force.

### BACKGROUND ART

Caliper style brakes include one or more stators having friction material adhered to one side. The actuating mechanism of the brake causes the stators to selectively engage a rotor positioned adjacent thereto to cause a braking force to be applied. Often, the stators are caused to move by one or more pistons that are actuated upon introduction of a pressurized fluid, such as, for example, oil. The pistons may be returned to their original position upon removal of the pressurized fluid due to the presence of a biasing mechanism. The biasing mechanism is typically a spring positioned between the opposing stators to provide a biasing force in a direction opposite the direction of actuation, often referred to as a return spring.

In some caliper braking systems, especially those that require a relatively high braking force, such as dump trucks and other off-road vehicles, problems have been encountered with the strength of the return spring. In these instances, some residual pressure remains in the hydraulic system of the brake after the actuating mechanism is released that is not overcome by the biasing force of the return spring. Thus, the stators are not fully returned to their unactuated position and detrimentally continue to apply a braking force to the rotor. This failure to fully return the stators also results in increased wear on the friction pad of the stators, thereby requiring increased maintenance.

One attempt at improving the performance of the return spring in caliper brakes installed on heavy industrial equipment has been to simply provide a stronger spring, thereby increasing the biasing force that returns the stators to their unactuated position. However, stronger springs cannot compress as far as weaker springs, and therefore have a taller solid height (the height, or length, of the spring at complete compression). Therefore, the stators are unable to travel far enough to utilize all of the friction material secured to the stators, and must be replaced more frequently than in a caliper brake with springs having a solid height that allows for use of the entire friction pad.

Thus, the need exists for an improved caliper braking system that provides a greater return force to the stators while also allowing use of the entire friction pad.

### DISCLOSURE OF THE INVENTION

It is thus an object of one aspect of the present invention to provide a caliper brake with an improved return spring assembly.

It is an object of another aspect of the present invention to provide a caliper brake, as above, with a return spring assembly that includes a high biasing force.

It is an object of yet another aspect of the present invention to provide a caliper brake, as above, including a mechanism for safely replacing the stators.

These and other objects of the present invention, as well as the advantages thereof over existing prior art forms, which will become apparent from the description to follow, are accomplished by the improvements hereinafter described and claimed.

In general, a caliper brake according to the concepts of the present invention includes a caliper brake having a first stator assembly, a second stator assembly spaced from the first stator assembly, and a return spring assembly, said return spring assembly including a first off-set bracket extending from the first stator assembly, a second off-set bracket extending from the second stator assembly, and a return spring positioned between the first and second off-set brackets.

In accordance with at least one aspect of the present invention, a caliper brake includes a pair of stator pins, a first stator assembly slidably positioned on the stator pins, a second stator assembly slidably positioned on the stator pins and spaced from the first stator assembly, and a return spring assembly, said return spring assembly including a first off-set bracket extending from the first stator assembly, a second off-set bracket extending from the second stator assembly, and a return spring positioned between the first and second off-set brackets, wherein a gap between the off-set brackets at the position of the return spring is greater than a gap between the off-set brackets at the point of connection to the first and second stator assemblies. A preferred exemplary caliper brake according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is an elevational view of a brake assembly made in accordance with the present invention.

FIG. 2 is a sectional view taken substantially along line 2-2 of FIG. 1.

FIG. 3 is a top plan view of the brake showing the return springs.

FIG. 4 is a side elevational view of the brake showing a return spring and a pair off-set brackets.

FIG. 5 is a sectional view of a return spring assembly taken substantially along line 5-5 of FIG. 3.

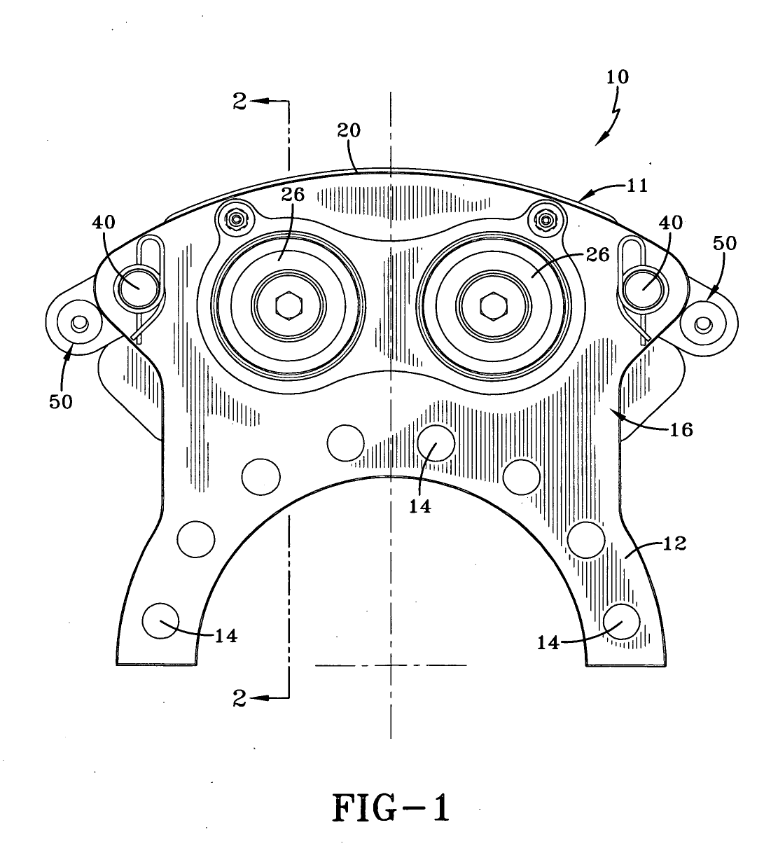

### PREFERRED EMBODIMENT FOR CARRYING OUT THE INVENTION

A brake made in accordance with the present invention is indicated generally by the numeral 10 and includes a housing 11 that carries and protects the operating components of brake 10. Housing 11 may include a mounting plate 12 on one side that includes a plurality of holes 14 therethrough. Brake 10 may be secured to a machine or vehicle frame by a plurality of bolts (not shown) that are inserted through holes 14 in mounting bracket 12. Brake 10 is positioned over a rotor of the machine or vehicle for selective frictional engagement therewith.

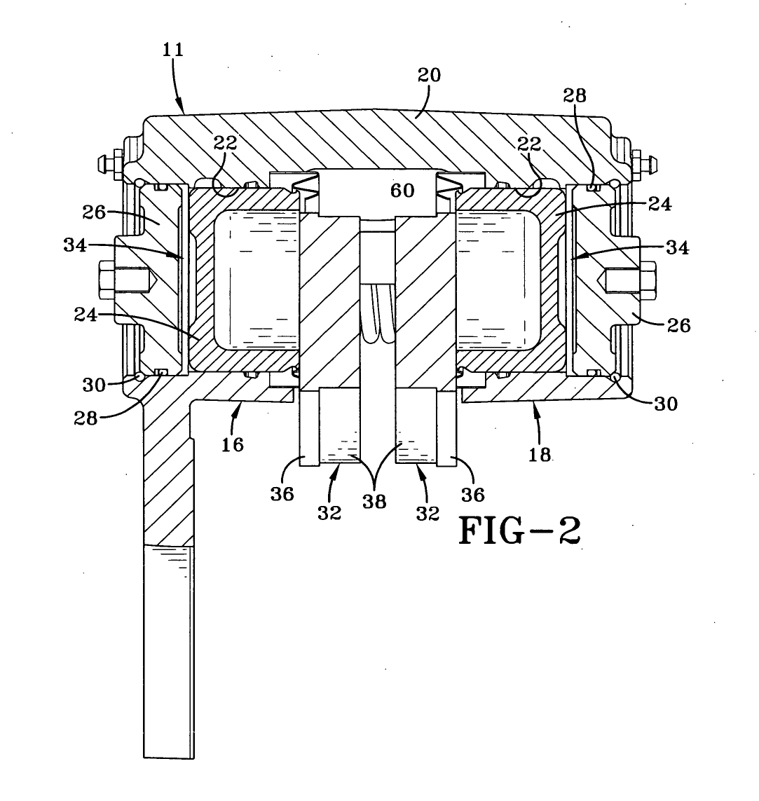

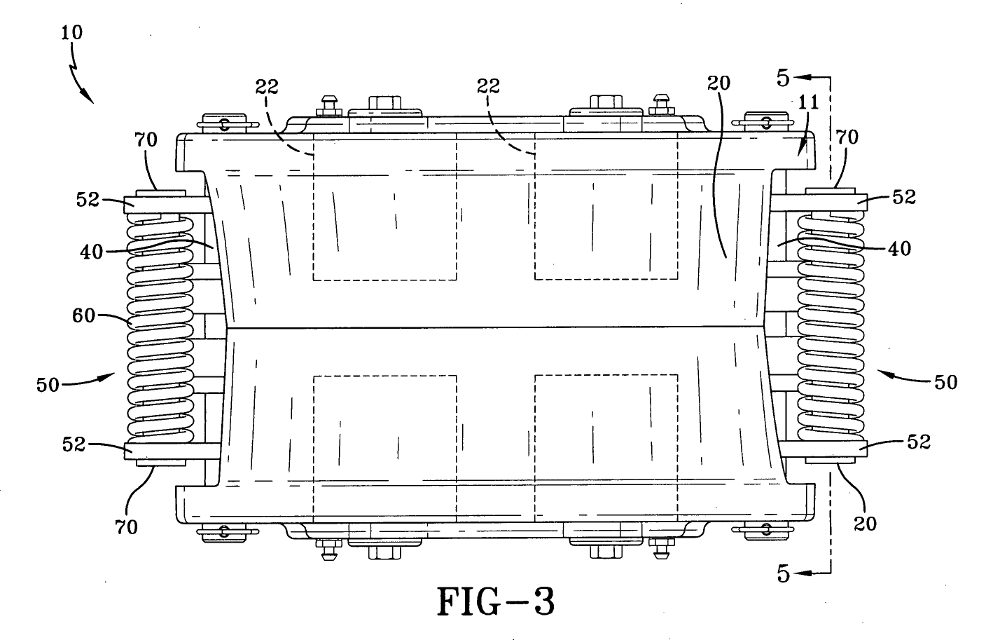

Referring now to FIG. 2, housing 11 includes a first housing half 16 and a second housing half 18 opposed from first housing half 16. Housing halves 16 and 18 are joined by a bridge 20 so that, in cross-section, housing 11 is generally in the shape of an inverted U. Each housing half 16 and 18 includes a pair of bores 22 that are each adapted to receive a piston 24 therein. It should be appreciated that, though the present embodiment discloses two pistons 24 in each housing half, it is contemplated that each housing half may include just a single piston, or more than two pistons. An end cap 26 is provided adjacent to the outer opening of each bore 22. End caps 26 may be secured within bores 22 by any mechanism known to those skilled in the art such as, for example, by providing a C-ring 30 that is received in a recess within bore 22.

As will be appreciated by those skilled in the art, pistons 24 are axially movable within bores 22 to selectively apply pressure to spaced stator assemblies 32. Piston movement is caused by the introduction of pressurized fluid into a chamber 34 formed between end cap 26 and piston 24. A gasket 28 is provided around the outer periphery of each end cap 26 to prevent fluid from escaping from chamber 34. Each stator assembly 32 includes a stator plate 36 with a friction material 38 bonded thereto. As shown in FIG. 2, piston 24 engages a surface of stator plate 36 opposed from the friction material 38. Thus, when pressurized fluid is communicated to chambers 34, the opposed stator assemblies 32 are pushed toward each other and engage a rotor (not shown) to cause a braking force to be applied.

Stator assemblies 32 each include a pair of holes that are adapted to receive a stator pin 40 therethrough. The holes in the stator assemblies are aligned so that each stator pin 40 passes through both stator assemblies 32. Stator pin 40 also is received through holes or in recesses in housing 11. As will be appreciated by those skilled in the art, stator assemblies 32 are capable of axial movement along stator pins 40. Each stator assembly 32 is movable between an unactuated position, in which the pistons 24 apply little or no force to stator assemblies 32, and an actuated position, in which the stator assemblies 32 are forced toward each other by the pistons 24 until friction material 38 of the stator assemblies contacts a rotor.

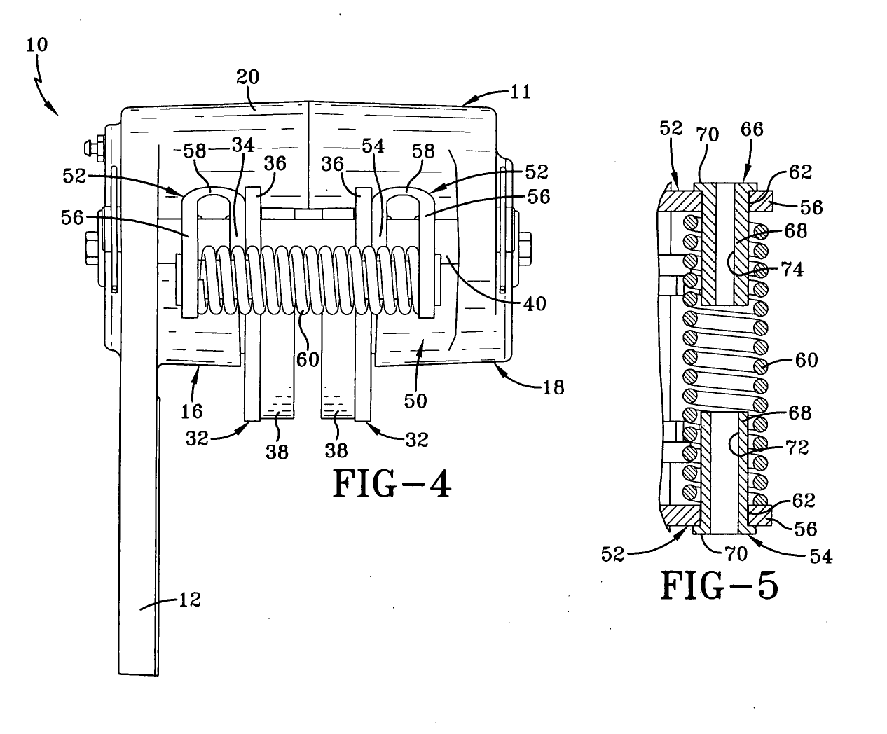

Referring to FIG. 4, stator assemblies 32 are biased in the unactuated position by a pair of return spring assemblies 50 located at the ends of stator plates 36. Each return spring assembly 50 includes an off-set bracket 52 extending from each end of each stator plate 36 of the stator assemblies 32. Thus, brake 10 includes a total of four off-set brackets, each bracket extending outwardly from an end of one of the stator plates 36.

Each off-set bracket 52 includes a generally planar mounting portion 54 adjacent stator plate 36, a generally planar support portion 56, and a connecting portion 58 extending between the mounting portion 54 and the support portion 56. Connecting portion 58 may be provided in any desired form or shape, but in the embodiment shown in the drawings the connecting portion 58 is curved and rounded. Mounting portion 54 is axially displaced, in a direction parallel to the orientation of stator pins 40, from support portion 56. In addition, mounting portion 54 is laterally displaced, in a direction perpendicular to the orientation of stator pins 40, from support portion 56.

As is apparent from FIG. 4, the distance between support portions 56 of the off-set brackets 52 of a return spring assembly is greater than the distance between stator plates 36 of the spaced stator assemblies 32. Off-set brackets 52 thus provide space therebetween for a longer and stronger compression spring 60 compared to traditional return spring assemblies that position a compression spring between stator plates 36 and over stator pin 40. Off-set brackets 52 may be integrally formed as a part of the stator plates 36, or may be secured thereto by any known connecting mechanism, such as, for example, by welding. The compression springs 60 are preferably positioned on an axis that is generally parallel with the axis of pistons 24.

Referring to FIG. 5, each off-set bracket 52 includes an aperture 62 through the support portion 56. The apertures 62 in support portions 56 of opposing off-set brackets 52 are substantially aligned and generally coaxial.

A first spring retaining member 64 is secured in the aperture 62 in a first off-set bracket 52, and a second spring retaining member 66 is secured in the aperture 62 of a second off-set bracket 52. Like apertures 62, first spring retaining member 64 and second spring retaining member 66 are generally coaxial. Both first and second spring retaining members 64 and 66 include a generally cylindrical body 68 and an outwardly extending flange 70 at one end. Spring retaining members 64 and 66 may be secured in apertures 62 by any known method. For example, retaining members 64 and 66 may be press fit in apertures 62.

First spring retaining member 64 includes a non-threaded bore 72 therein, and second spring retaining member 66 includes a threaded bore 74 therein. Bore 72 through first spring retaining member 64 and threaded bore 74 through second spring retaining member 66 are generally coaxial and are substantially aligned. Non-threaded bore 72 has a diameter that is large enough to allow a threaded bolt sized to engage threaded bore 74 to pass therethrough without significant resistance.

Compression spring 60, also referred to as a return spring, is received over first and second spring retaining members 64 and 66 and between support portions 56 of off-set brackets 52. As will be apparent to those skilled in the art, compression spring 60 provides a biasing force to stator assemblies 32 through off-set brackets 52. Any compression spring known to those skilled in the art and capable of providing the requisite biasing force may be used in return spring assemblies 50.

First and second spring retaining members 64 and 66, bore 72 and threaded bore 74 together provide a mechanism for compressing return spring 60 prior to installing or removing stator assemblies 32 from brake 10. A bolt (not shown) having a threaded end may be inserted through bore 72 in first spring retaining member 64 and may then engage threaded bore 74 in second spring retaining member 66. As will be appreciated by those skilled in the art, rotation of the bolt in a first direction will cause first and second spring retaining members and, consequently, stator assemblies 32, to move toward one another. Rotation in a second direction will cause stator assemblies to move apart. After compressing the return spring 60 on each side of the stator assemblies 32, stator pins 40 may be removed or inserted from housing 11 and stator plates 36, thereby allowing both stator assemblies 32 and the return spring assemblies 50 to be easily replaced. Removal of the threaded bolt from threaded bore 74 will allow the stator assemblies to return to their original position.

In view of the foregoing, it should thus be evident that a brake as described herein accomplishes the objects of the present invention and otherwise substantially improves the art.

What is claimed is:

1. A caliper brake comprising a first stator assembly, a second stator assembly spaced from said first stator assembly, and a return spring assembly, said return spring assembly including a first off-set bracket extending from said first stator assembly, a second off-set bracket extending from said second stator assembly, and a return spring positioned between said first and second off-set brackets.

2. The caliper brake of claim 1, wherein a return spring assembly is provided at each end of said first and second stator assemblies.

3. The caliper brake of claim 1, further comprising a pair of stator pins, said first and second stator assemblies being slidably mounted on said stator pins.

4. The caliper brake of claim 1, said first and second stator assemblies each including a stator plate and a friction pad secured to said stator plate.

5. The caliper brake of claim 3, wherein said first and second stator assemblies each include a stator plate and a friction pad and are positioned on said stator pins so that said friction pads of said first and second stator assemblies face each other.

6. The caliper brake of claim 1, further comprising a housing, said housing including a mounting bracket.

7. The caliper brake of claim 1, wherein said off-set brackets are integral with said first and second stator assemblies.

8. The caliper brake of claim 1, wherein said off-set brackets are secured to said first and second stator assemblies by a weldment.

9. The caliper brake of claim 4, wherein each said offset bracket includes a generally planar support portion and a generally planar mounting portion, both said support portion and said mounting portion being oriented on a plane substantially parallel to said stator plate from which said offset bracket extends.

10. The caliper brake of claim 9, wherein said support portion is displaced from said mounting portion in a direction parallel to the orientation of said stator pins.

11. The caliper brake of claim 10, wherein a gap between said support portions is larger than a gap between said stator plates of said stator assemblies.

12. The caliper brake of claim 9, wherein each support portion of said off-set brackets includes a hole therethrough, and a return spring retaining member positioned in said hole and extending into the gap between said support portions.

13. The caliper brake of claim 12, wherein one of said retaining members in a return spring assembly includes a bore therethrough, and the other of said retaining members including a threaded bore therein.

14. A caliper brake comprising a pair of stator pins, a first stator assembly slidably positioned on said stator pins, a second stator assembly slidably positioned on said stator pins and spaced from said first stator assembly, and a return spring assembly, said return spring assembly including a first off-set bracket extending from said first stator assembly, a second off-set bracket extending from said second stator assembly, and a return spring positioned between said first and second off-set brackets, wherein a gap between said off-set brackets at the position of said return spring is greater than a gap between said off-set brackets at the point of connection to said first and second stator assemblies.

15. The caliper brake of claim 14, further comprising a housing and holes in said housing, said stator pins being received through said holes in said housing.

16. The caliper brake of claim 14, wherein said first and second stator assemblies each include a stator plate and a friction pad secured to said stator plate.

17. The caliper brake of claim 14, wherein said off-set brackets each include a generally planar mounting portion, a generally planar support portion, and a connecting portion, said support portion being displaced from said mounting portion in a direction parallel to the orientation of said stator pins and in a direction perpendicular to the orientation of said stator pins.

18. The caliper brake of claim 14, wherein each off-set bracket of said return spring assembly includes a spring retaining member extending into said gap between said off-set brackets at the position of said return spring, said return spring being positioned around said retaining members.

19. The caliper brake of claim 18, wherein one of said retaining members in said return spring assembly includes a bore therethrough, and the other of said retaining members including a threaded bore therein.

20. The caliper brake of claim 14, wherein said off-set brackets are secured to said stator assemblies by a weldment.
